(19) United States
(12) Patent Application Publication
(10) Pub. No.: US 2007/0245122 A1
(43) Pub. Date: Oct. 18, 2007

(54) Executing an Allgather Operation on a Parallel Computer

(76) Inventors: Charles J. Archer, Rochester, MN (US); Jose E. Moreira, Yorktown Heights, NY (US); Joseph D. Ratterman, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/279,620

(22) Filed: Apr. 13, 2006

(51) Int. Cl. G06F 15/00

(52) U.S. Cl. 712/17

(57) ABSTRACT

Executing an allgather operation on a parallel computer that includes a plurality of compute nodes where the compute nodes are organized into at least one operational group of compute nodes for collective parallel operations of the parallel computer, and each compute node in the operational group is assigned a unique rank. In such a parallel computer, executing an allgather operation may include configuring on each compute node in an operational group of compute nodes a memory buffer with contribution data for an allreduce operation at a rank-dependent position in each memory buffer and zeros in all other positions in each memory buffer and executing on the compute nodes in the operational group, with the entire contents of each memory buffer, an allreduce operation with a bitwise OR function.

### STATEMENT REGARDING FEDERALLY SPONSORED RESEARCH OR DEVELOPMENT

This invention was made with Government support under Contract No. B519700 awarded by the Department of Energy. The Government has certain rights in this invention.

### BACKGROUND OF THE INVENTION

1. Field of the Invention

The field of the invention is data processing, or, more specifically, methods, apparatus, and products for executing an allgather operation on a parallel computer.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes. Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory need for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x,y,z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

A torus network lends itself to point to point operations, but a tree network typically is inefficient in point to point communication. A tree network, however, does provide high bandwidth and low latency for certain collective operations, message passing operations where all compute nodes participate simultaneously, such as, for example, an allgather. An allgather operation is a collective operation on an operational group of compute nodes that gathers data from all compute nodes in the operational group, concatenates the gathered data into a memory buffer in rank order, and provides the entire contents of the memory buffer to all compute nodes in the operational group. Because thousands of nodes may participate in collective operations on a parallel computer, executing an allgather operation on a parallel computer is always a challenge. A typical prior art algorithm for carrying out an allgather is for each computer node in the operational group to broadcast its contribution of data to all the compute nodes in the operational group. If the group is large, and such groups may contain thousands of compute nodes, then the data communications cost of such an algorithm is substantial.

### SUMMARY OF THE INVENTION

Methods, apparatus, and computer program products are disclosed for executing an allgather operation on a parallel computer that includes a plurality of compute nodes where the compute nodes are organized into at least one operational group of compute nodes for collective parallel operations of the parallel computer, and each compute node in the operational group is assigned a unique rank. In such a parallel computer, executing an allgather operation may include configuring on each compute node in an operational group of compute nodes a memory buffer with contribution data for an allreduce operation at a rank-dependent position in each memory buffer and zeros in all other positions in each memory buffer and executing on the compute nodes in the operational group, with the entire contents of each memory buffer, an allreduce operation with a bitwise OR function.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary system for computer executing an allgather operation on a parallel computer according to embodiments of the present invention.

FIG. 2 sets forth a block diagram of an exemplary compute node useful in executing an allgather operation on a parallel computer according to embodiments of the present invention.

FIG. 3A illustrates an exemplary Point To Point Adapter useful in systems that execute an allgather operation on a parallel computer according to embodiments of the present invention.

FIG. 3B illustrates an exemplary Collective Operations Adapter useful in systems that execute an allgather operation on a parallel computer according to embodiments of the present invention.

FIG. 4 illustrates an exemplary data communications network optimized for point to point operations.

FIG. 5 illustrates an exemplary data communications network optimized for collective operations.

FIG. 6 sets forth a flow chart illustrating an exemplary method of executing an allgather operation on a parallel computer according to embodiments of the present invention.

FIGS. 7A, 7B, and 7C set forth block diagrams of the organizational group of compute nodes illustrated on FIG. 6.

FIG. 8 sets forth a flow chart illustrating a further exemplary method of executing an allgather operation on a parallel computer according to embodiments of the present invention.

FIGS. 9A-9E set forth block diagrams of the organizational group of compute nodes illustrated on FIG. 8.

### DETAILED DESCRIPTION OF EXEMPLARY EMBODIMENTS

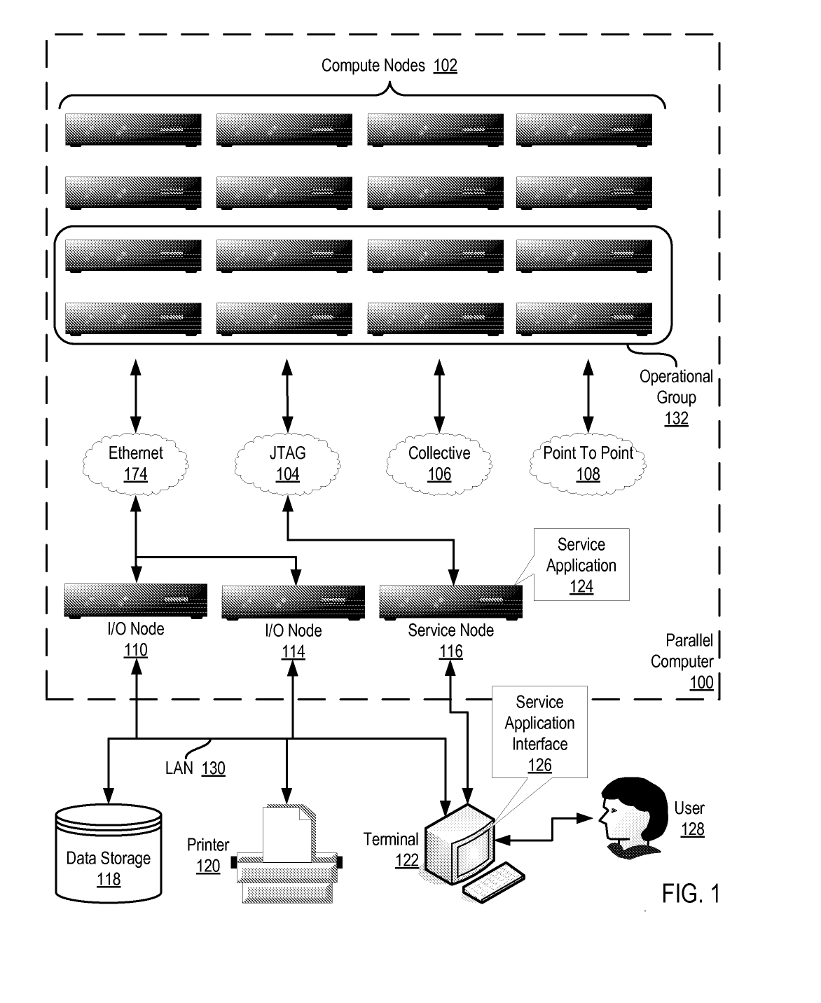

Exemplary methods, apparatus, and computer program products for executing an allgather operation on a parallel computer according to embodiments of the present invention are described with reference to the accompanying drawings, beginning with FIG. 1. FIG. 1 illustrates an exemplary system for executing an allgather operation on a parallel computer according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102).

The compute nodes (102) are coupled for data communications by several independent data communications networks including a high speed Ethernet network (174), a Joint Test Action Group (‘JTAG’) network (104), a tree network (106) which is optimized for collective operations, and a torus network (108) which is optimized point to point operations. Tree network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operations for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for executing an allgather operation on a parallel computer according to embodiments of the present invention include MPI and the ‘Parallel Virtual Machine’ (‘PVM’) library. PVM was developed by the University of Tennessee, The Oak Ridge National Laboratory and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

As described in more detail below in this specification, the system of FIG. 1 operates generally to execute an allgather operation on a parallel computer according to embodiments of the present invention by configuring on each compute node in an operational group of compute nodes a memory buffer with contribution data for an allreduce operation at a rank-dependent position in each memory buffer and zeros in all other positions in each memory buffer and executing on the compute nodes in the operational group, with the entire contents of each memory buffer, an allreduce operation with a bitwise OR function.

A ‘bitwise OR function,’ as the term is used in this specification, is an inclusive bitwise OR rather than an exclusive bitwise OR. The symbol for the inclusive bitwise OR function in the C and C++ programming languages is ‘|’. The inclusive bitwise OR function conducts a logical OR function separately on each bit of its operands. The effect is to turn bits on. For these operands, for example,
x=00000000 00000001 00000000, in decimal, x=010, and
y=00000000 00000000 00000010, in decimal, y=002,

x=x|y yields x=00000000 00000001 00000010, in decimal, x=012. That is, all the bits that were on in each operand are also on in the result of the bitwise OR function.

An allreduce operation with a bitwise OR function is a collective operation on an operational group of compute nodes that combines, through the bitwise OR function, contributions of data from all compute nodes in the operational group and transmits the combined contributions to all compute nodes in the operational group. As mentioned above, an allgather operation is a collective operation on an operational group of compute nodes that gathers data from all compute nodes in the operational group, concatenates the gathered data into a memory buffer in rank order, and broadcasts the entire contents of the memory buffer to all compute nodes in the operational group. The functions of an allreduce operation and an allgather operation are defined in the MPI standards promulgated by the MPI Forum. Algorithms for executing collective operations, including the functions of an allreduce operation and an allgather operation, are not defined in the MPI standards.

Most collective operations are variations or combinations of four basic operations: broadcast, gather, scatter, and reduce. In a broadcast operation, all processes specify the same root process, whose buffer contents will be sent. Processes other than the root specify receive buffers. After the operation, all buffers contain the message from the root process.

A scatter operation, like the broadcast operation, is also a one-to-many collective operation. All processes specify the same receive count. The send arguments are only significant to the root process, whose buffer actually contains sendcount * N elements of a given datatype, where N is the number of processes in the given group of compute nodes. The send buffer will be divided equally and dispersed to all processes (including itself). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gather from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, computer (100) includes input/output (‘I/O’) nodes (110, 114) coupled to compute nodes (102) through one of the data communications networks (174). The I/O nodes (110, 114) provide I/O services between compute nodes (102) and I/O devices (118, 120, 122). I/O nodes (110, 114) are connected for data communications I/O devices (118, 120, 122) through local area network (‘LAN’) (130). Computer (100) also includes a service node (116) coupled to the compute nodes through one of the networks (104). Service node (116) provides service common to pluralities of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

The arrangement of nodes, networks, and I/O devices making up the exemplary system illustrated in FIG. 1 are for explanation only, not for limitation of the present invention. Data processing systems capable of executing an allgather operation on a parallel computer according to embodiments of the present invention may include additional nodes, networks, devices, and architectures, not shown in FIG. 1, as will occur to those of skill in the art. The parallel computer (100) in the example of FIG. 1 includes sixteen compute nodes (102); parallel computers capable of executing an allgather operation according to embodiments of the present invention sometimes include thousands of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

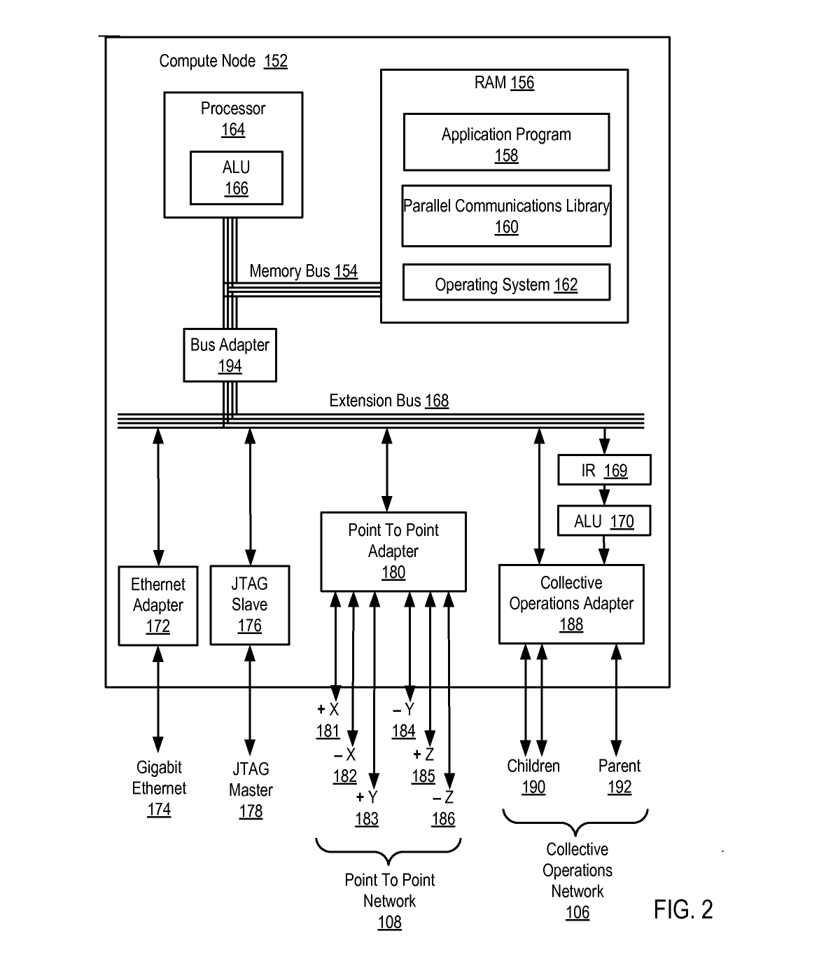

Executing an allgather operation according to embodiments of the present invention is generally implemented on a parallel computer that includes a plurality of compute nodes. In fact, such computers may include thousands of such compute nodes. Each compute node is in turn itself a kind of computer composed of one or more computer processors, its own computer memory, and its own input/output adapters. For further explanation, therefore, FIG. 2 sets forth a block diagram of an exemplary compute node useful in a parallel computer capable of executing an allgather operation according to embodiments of the present invention. The compute node (152) of FIG. 2 includes at least one computer processor (164) as well as random access memory (‘RAM’) (156). Processor (164) is connected to RAM (156) through a high-speed memory bus (154) and through a bus adapter (194) and a extension bus (168) to other components of the compute node. Stored in RAM (156) is an application program (158), a module of computer program instructions that carries out parallel, user-level data processing using parallel algorithms.

Also stored RAM (156) is a parallel communications library (160), a library of computer program instructions that carry out parallel communications among compute nodes, including point to point operations as well as collective operations. Application program (158) executes collective operations by calling software routines in parallel communications library (160). A library of parallel communications routines may be developed from scratch for use in executing an allgather operation on a parallel computer according to embodiments of the present invention, using a traditional programming language such as the C programming language, and using traditional programming methods to write parallel communications routines that send and receive data among nodes on two independent data communications networks. Alternatively, existing prior art libraries may be used. Examples of prior-art parallel communications libraries that may be improved for executing an allgather operation on a parallel computer according to embodiments of the present invention include the ‘Message Passing Interface’ (‘MPI’) library and the ‘Parallel Virtual Machine’ (‘PVM’) library. However it is developed, the parallel communications routines of parallel communication library (160) are improved to execute an allgather operation according to embodiments of the present invention by configuring on each compute node in an operational group of compute nodes a memory buffer with contribution data for an allreduce operation at a rank-dependent position in each memory buffer and zeros in all other positions in each memory buffer and executing on the compute nodes in the operational group, with the entire contents of each memory buffer, an allreduce operation with a bitwise OR function.

Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in systems that execute allgather operations according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in executing allgather operations according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Collective Operations Adapter (188) that couples example compute node (152) for data communications to a network (106) that is optimal for collective message passing operations such as, for example, a network configured as a binary tree. Collective Operations Adapter (188) provides data communications through three bidirectional links: two to children nodes (190) and one to a parent node (192).

Example compute node (152) includes two arithmetic logic units (‘ALUs’). ALU (166) is a component of processor (164), and a separate ALU (170) is dedicated to the exclusive use of collective operations adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, collective operations adapter (188) may execute the arithmetic or logical operation by use of ALU (166) in processor (164) or, typically much faster, by use dedicated ALU (170).

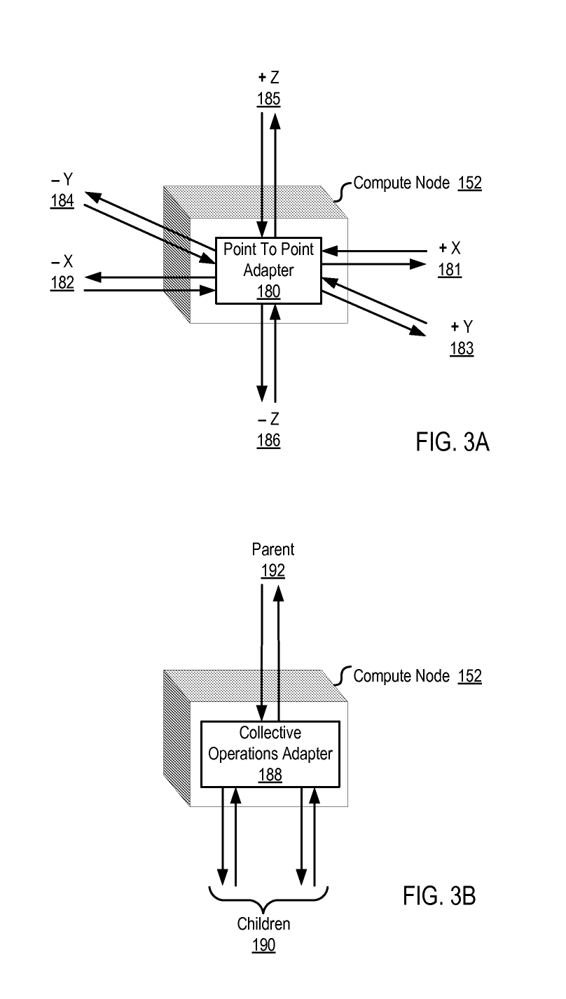

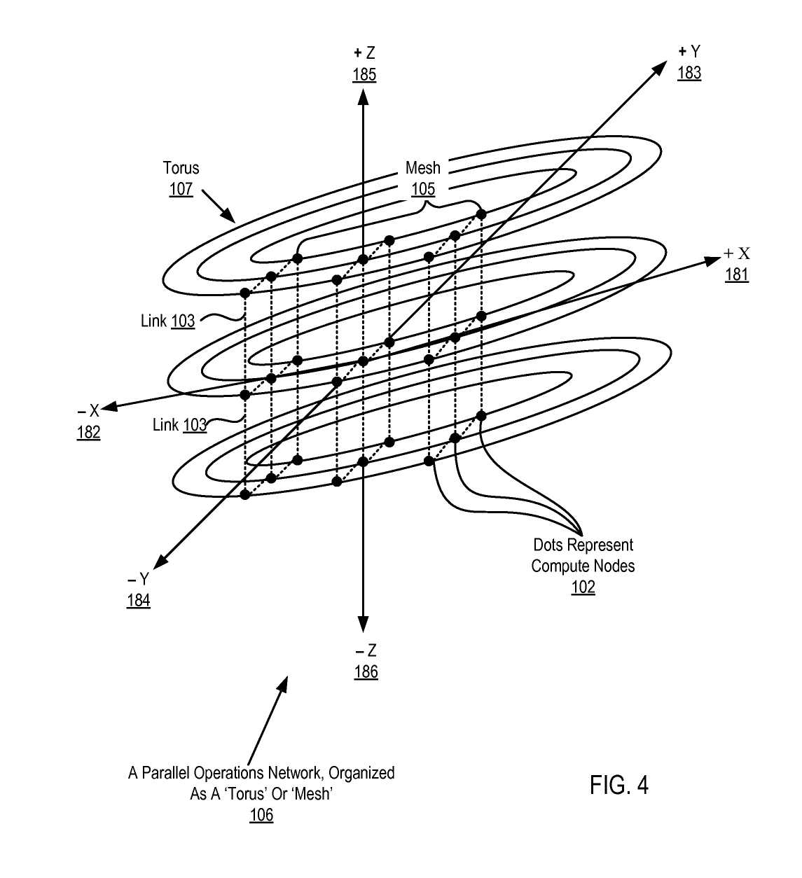

For further explanation, FIG. 3A illustrates an exemplary Point To Point Adapter (180) useful in systems that execute allgather operations according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the -y direction (184) and to and from the next node in the +y direction (183). Point To Point Adapter (180) in also provides data communication along a z-axis through four unidirectional data communications links, to and from the next node in the −z direction (186) and to and from the next node in the +z direction (185).

For further explanation, FIG. 3B illustrates an exemplary Collective Operations Adapter (188) useful in systems that execute allgather operations according to embodiments of the present invention. Collective Operations Adapter (188) is designed for use in a network optimized for collective operations, a network that organizes compute nodes of a parallel computer in a binary tree. Collective Operations Adapter (188) in the example of FIG. 3B provides data communication to and from two children nodes through four unidirectional data communications links (190). Collective Operations Adapter (188) also provides data communication to and from a parent node through two unidirectional data communications links (192).

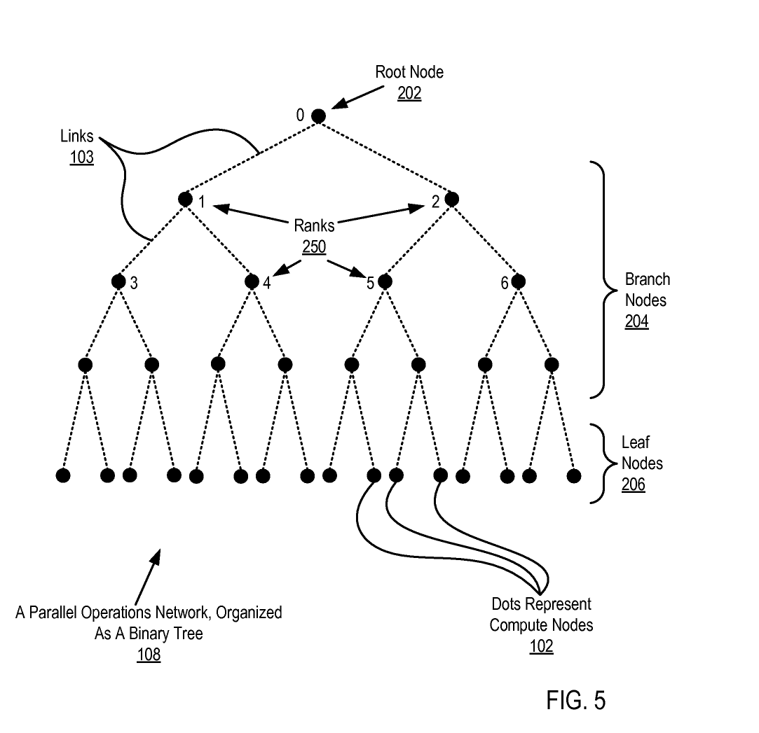

For further explanation, FIG. 4 illustrates an exemplary data communications network optimized for point to point operations (106). In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and fro in six directions +x (181), −x (182), +y (183), −y (184), +z (185), and −z (186). The links and compute nodes are organized by this data communications network optimized for point to point operations into a three dimensional mesh (105) that wraps around to form a torus (107). Each compute node in the torus has a location in the torus that is uniquely specified by a set of x, y, z coordinates. For clarity of explanation, the data communications network of FIG. 4 is illustrated with only 27 compute nodes, but readers will recognize that a data communications network optimized for point to point operations for use in executing an allgather operation on accordance with embodiments of the present invention may contain only a few compute nodes or may contain thousands of compute nodes.

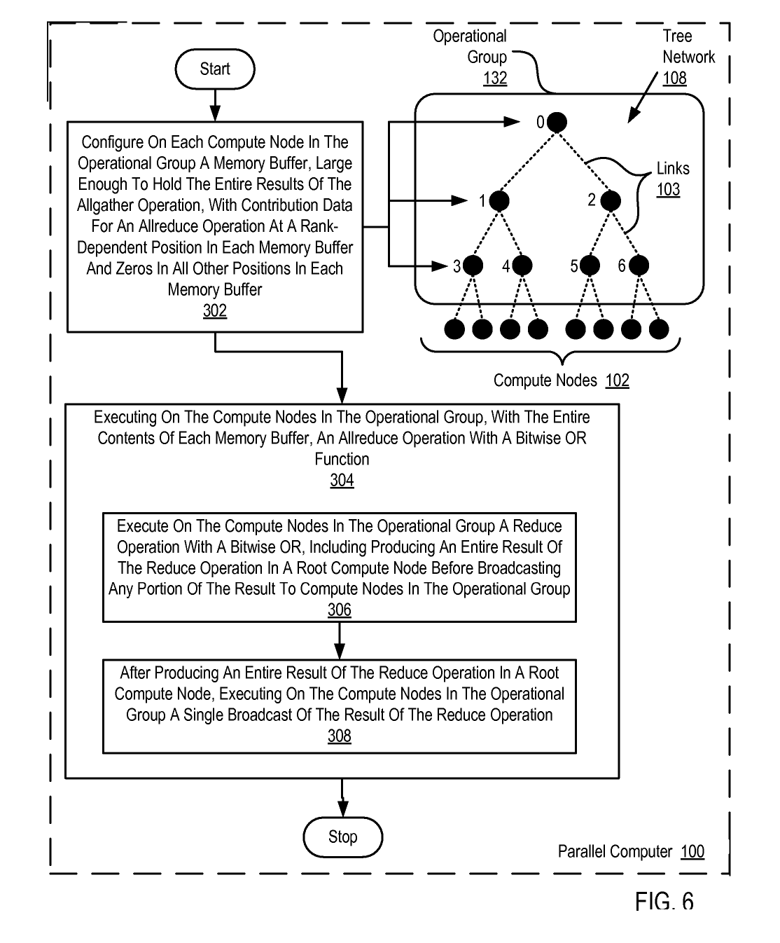

For further explanation, FIG. 5 illustrates an exemplary data communications network (108) optimized for collective operations by organizing compute nodes in a tree. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with collective operations data communications adapters similar to the one illustrated for example in FIG. 3B, with each node typically providing data communications to and from two children nodes and data communications to and from a parent node, with some exceptions. Nodes in a binary tree may be characterized as a root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (108). For clarity of explanation, the data communications network of FIG. 5 is illustrated with only 31 compute nodes, but readers will recognize that a data communications network optimized for collective operations for use in executing an allgather operation on accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

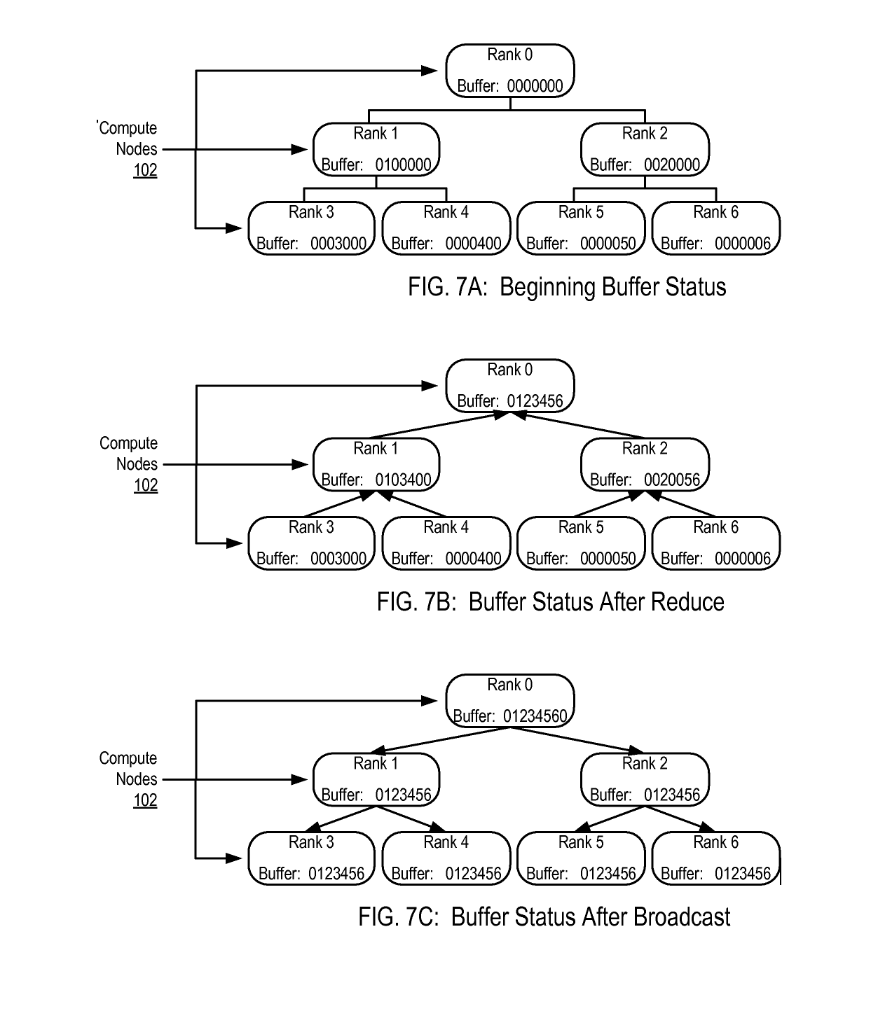

For further explanation, FIG. 6 sets forth a flow chart illustrating an exemplary method for executing an allgather operation on a parallel computer (100) according to embodiments of the present invention. The parallel computer includes a plurality of compute nodes (102), represented here by black dots in tree network (108). Tree network (108) is a data communications network of parallel computer (100) that includes data communications links (103) connected to the compute nodes so as to organize the compute nodes as a tree. In this examples, the data communications links (103) are represented by dotted lines connecting the dots that represent the compute nodes (102). In additional in this example, each compute node has a separate ALU dedicated to parallel reduce operations. The separate, dedicated ALUs are not shown in FIG. 6, but they are of the kind illustrated and described above regarding reference (170) on FIG. 2.

In addition to their organization as a tree, the compute nodes (102) of parallel computer (100) are organized into an operational group (132) of compute nodes for collective parallel operations on parallel computer (100), and each compute node in the operational group is assigned a unique rank. The ranks are shown here as integers immediately left adjacent to each computer node in operational group (132). The ranks in this example are assigned as a sequence of integers beginning with 0 assigned to the root node, 1 assigned to the first node in the second layer of the tree, 2 assigned to the second node in the second layer of the tree, 3 assigned to the first node in the third layer of the tree, and so on.

The method of FIG. 6 includes configuring (302) on each compute node in the operational group a memory buffer with contribution data for an allreduce operation at a rank-dependent position in each memory buffer and zeros in all other positions in each memory buffer. The method of FIG. 6 also includes executing (304) on the compute nodes in the operational group, with the entire contents of each memory buffer, an allreduce operation with a bitwise OR function.

In the method of FIG. 6, executing (304) the allreduce includes executing (306) on the compute nodes in the operational group a reduce operation with a bitwise OR, including producing an entire result of the reduce operation in a root compute node before broadcasting any portion of the result to compute nodes in the operational group. In the method of FIG. 6, executing (304) the allreduce also includes executing (308) on the compute nodes in the operational group a single broadcast of the result of the reduce operation after producing an entire result of the reduce operation in a root compute node.

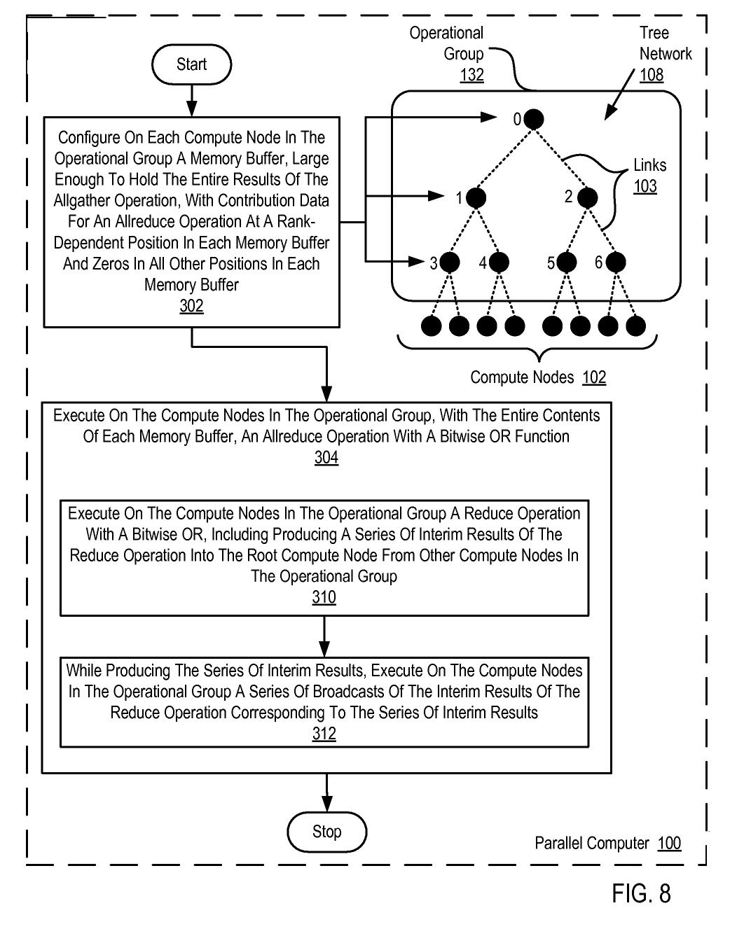

The method of FIG. 6 is explained further with reference to FIGS. 7A, 7B, and 7C. FIGS. 7A, 7B, and 7C set forth block diagrams of the same organizational group of compute nodes (102) illustrated at reference (132) on FIG. 6. Read together, FIGS. 7A, 7B, and 7C illustrate a sequence of execution of the method of FIG. 6 with changes in buffer status.

FIG. 7A illustrates the status of the memory buffers in each compute node (102) of the operational group just after configuring the memory buffers in step (302) of the method of FIG. 6. Each memory buffer is large enough to hold the entire results of an allgather operation. Each memory buffer is configured with contribution data for an allreduce operation. The contribution data in each memory buffer is located at a position that corresponds to the rank of the compute node in which the memory buffer is located, and all other positions in each memory buffer are set to 0. The contribution data is taken for convenience of explanation as an integer representing the rank of each compute node, 0 for the root node, 1 for compute node 1, 2 for compute node 2, and so on. The root compute node, rank zero, has a 0 for contribution data in the 0th position of its buffer and 0s in all other buffer position. The compute node with rank 1 has a 1 for contribution data in the 1st position of its buffer and 0s in all other buffer positions. The compute node with rank 2 has a 2 for contribution data in the 2nd position of its buffer and 0s in all other buffer positions. And so on, for all the buffers in all the compute node of the operational group.

FIG. 7B illustrates the status of the memory buffers in each compute node (102) of the operational group just after executing the reduce operation in step (306) of the method of FIG. 6. The contents of each memory buffer have been bitwise ORed with the contents of all memory buffers lower in the tree. The contents of the buffer of the compute node of rank 1, 0100000, are bitwise ORed with the contents of the buffers of the compute nodes of rank 3 and rank 4, 0003000 and 0000400 respectively, yielding 0103400 in the buffer of the compute node of rank 1. The contents of the buffer of the compute node of rank 2, 0020000, are bitwise ORed with the contents of the buffers of the compute nodes of rank 5 and rank 6, 0000050 and 0000006 respectively, yielding 0020056 in the buffer of the compute node of rank 2. The contents of the buffer of the compute node of rank 0, 0000000, are bitwise ORed with the contents of the buffers of the compute nodes of rank 1 and rank 2, 0103400 and 0020056 respectively, yielding 0123456 in the buffer of the compute node of rank 0. This processing step is effected with a reduce operation and a bitwise OR, but its effect is that of a gather of the contribution data from each compute node into the buffer of the root compute node at rank positions in the buffer.

FIG. 7C illustrates the status of the memory buffers in each compute node (102) of the operational group just after executing the broadcast operation in step (308) of the method of FIG. 6. The contents of the buffer of the root compute node, rank 0, that is, 0123456, have been broadcast to all the compute nodes in the operational group, and all buffers in the operational group now contain the same value, 0123456. Broadcasting the results of the reduce operation effects an allreduce, step (304) in the method of FIG. 6. The effect of the allreduce combined with the initial configuration of the buffers is an allgather, a gather of the contribution data from each compute node into the buffer of the root compute node at rank positions in the buffer followed by a broadcast of the results of the gather to all compute nodes in the operational group.

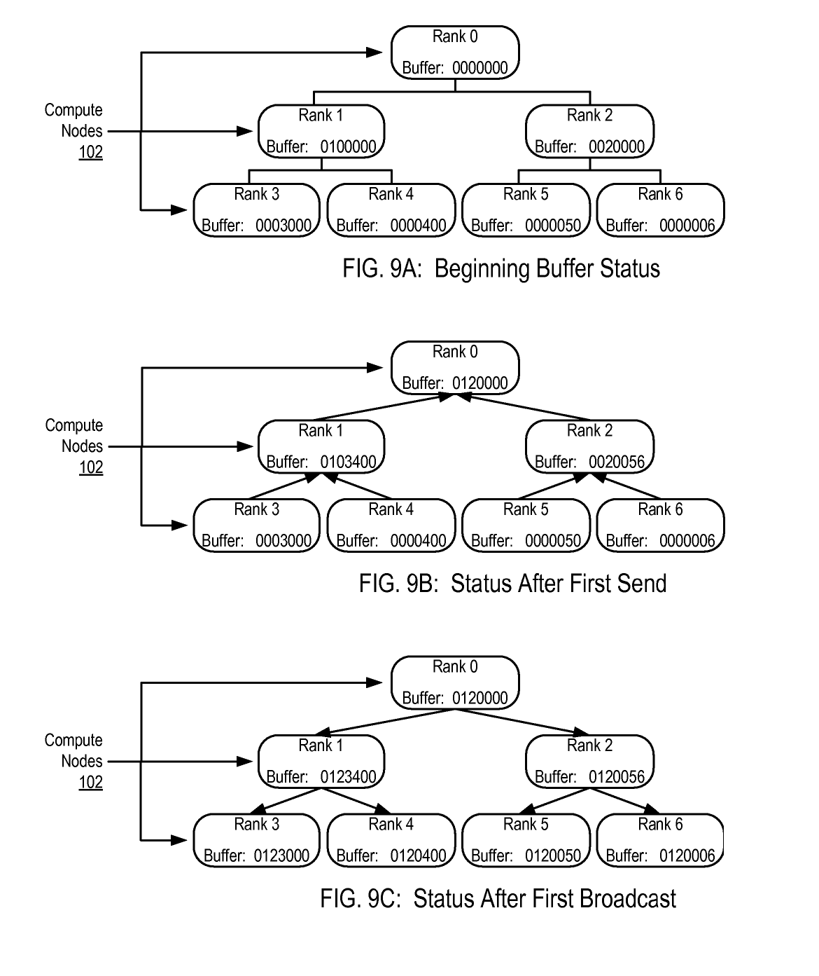

For further explanation, FIG. 8 sets forth a flow chart illustrating a further exemplary method for executing an allgather operation on a parallel computer according to embodiments of the present invention. The method of FIG. 8 is similar to the method of FIG. 6. Like the method of FIG. 6, the method of FIG. 8 is carried out on a parallel computer that includes a plurality of compute nodes (102) represented by black dots in tree network (108). Tree network (108) is a data communications network of parallel computer (100) that includes data communications links (103) connected to the compute nodes so as to organize the compute nodes as a tree. The data communications links (103) are represented by dotted lines connecting the dots that represent the compute nodes (102). Like the example of FIG. 6, each compute node has a separate ALU dedicated to parallel reduce operations. The separate, dedicated ALUs are not shown in FIG. 8, but they are of the kind illustrated and described above regarding reference (170) on FIG. 2.

In addition to their organization as a tree, the compute nodes (102) of parallel computer (100) are organized into an operational group (132) of compute nodes for collective parallel operations on parallel computer (100), and each compute node in the operational group is assigned a unique rank. The ranks are shown on FIG. 8 as integers immediately left adjacent to each computer node in operational group (132). The ranks are assigned as a sequence of integers beginning with 0 assigned to the root node, 1 assigned to the first node in the second layer of the tree, 2 assigned to the second node in the second layer of the tree, 3 assigned to the first node in the third layer of the tree, and so on.

Like the method of FIG. 6, the method of FIG. 8 includes configuring (302) on each compute node in the operational group a memory buffer with contribution data for an allreduce operation at a rank-dependent position in each memory buffer and zeros in all other positions in each memory buffer. The method of FIG. 8 also includes executing (304) on the compute nodes in the operational group, with the entire contents of each memory buffer, an allreduce operation with a bitwise OR function.

Unlike the method of FIG. 6, however, in the method of FIG. 8, executing (304) the allreduce includes executing (310) on the compute nodes in the operational group a reduce operation with a bitwise OR, including producing a series of interim results of the reduce operation into the root compute node from other compute nodes in the operational group. In the method of FIG. 8, executing (304) the allreduce also includes executing (312) on the compute nodes in the operational group a corresponding series of broadcasts of the interim results of the reduce operation while producing the series of interim results.

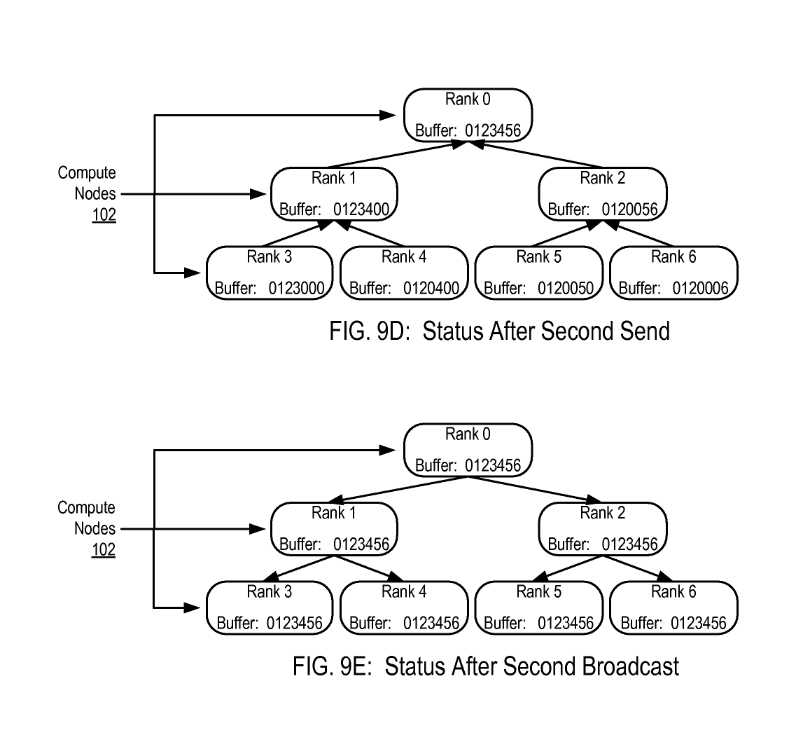

The method of FIG. 8 is explained further with reference to FIGS. 9A-9E. FIGS. 9A-9E set forth block diagrams of the same organizational group of compute nodes (102) illustrated at reference (132) on FIG. 8. Read together, FIGS. 9A-9E illustrate a sequence of execution of the method of FIG. 8 with changes in buffer status.

FIG. 9A illustrates the status of the memory buffers in each compute node (102) of the operational group just after configuring the memory buffers in step (302) of the method of FIG. 8. Each memory buffer is large enough to hold the entire results of an allgather operation. Each memory buffer is configured with contribution data for an allreduce operation. The contribution data in each memory buffer is located at a position that corresponds to the rank of the compute node in which the memory buffer is located, and all other positions in each memory buffer are set to 0. The contribution data is taken for convenience of explanation as an integer representing the rank of each compute node, 0 for the root node, 1 for compute node 1, 2 for compute node 2, and so on. The root compute node, rank zero, has a 0 for contribution data in the 0th position of its buffer and 0s in all other buffer position. The compute node with rank 1 has a 1 for contribution data in the 1st position of its buffer and 0s in all other buffer positions. The compute node with rank 2 has a 2 for contribution data in the 2nd position of its buffer and 0s in all other buffer positions. And so on, for all the buffers in all the compute node of the operational group.

FIG. 9B illustrates the status of the memory buffers in each compute node (102) of the operational group just after the production of the first of a series of interim results in the reduce operation of step (310) in the method of FIG. 8. The contents of each memory buffer have been bitwise ORed with the contents of all memory buffers lower in the next lower tier of the tree. The contents of the buffer of the compute node of rank 0, 0000000, are bitwise ORed with the contents of the buffers of the compute nodes of rank 1 and rank 2, 0100000 and 0020000 respectively, yielding 0120000 in the buffer of the compute node of rank 0. The contents of the buffer of the compute node of rank 1, 0100000, are bitwise ORed with the contents of the buffers of the compute nodes of rank 3 and rank 4, 0003000 and 0000400 respectively, yielding 0103400 in the buffer of the compute node of rank 1. The contents of the buffer of the compute node of rank 2, 0020000, are bitwise ORed with the contents of the buffers of the compute nodes of rank 5 and rank 6, 0000050 and 0000006 respectively, yielding 0020056 in the buffer of the compute node of rank 2.

FIG. 9E illustrates the status of the memory buffers in each compute node (102) of the operational group just after the first of a series of broadcasts of interim results in step (312) of the method of FIG. 8. The contents of the buffer of the root compute node, rank 0, that is, 0120000, have been broadcast to, and bitwise ORed with the previous buffer contents of, all the compute nodes in the operational group, so that:
The buffer in the compute node of rank 0 (ORed with its own previous contents), previously containing 0120000 now contains 0120000.
The buffer in the compute node of rank 1, previously containing 0103400 now contains 0123400.
The buffer in the compute node of rank 2, previously containing 0020056 now contains 0120056.
The buffer in the compute node of rank 3, previously containing 0003000 now contains 0123000.
The buffer in the compute node of rank 4, previously containing 0000400 now contains 0120400.
The buffer in the compute node of rank 1, previously containing 0000050 now contains 0120050.
The buffer in the compute node of rank 1, previously containing 0000006 now contains 0120006.

FIG. 9D illustrates the status of the memory buffers in each compute node (102) of the operational group just after the production of a second of a series of interim results in the reduce operation of step (310) in the method of FIG. 8. The contents of each memory buffer have been bitwise ORed with the contents of all memory buffers lower in the next lower tier of the tree. The contents of the buffer of the compute node of rank 0, 0120000, are bitwise ORed with the contents of the buffers of the compute nodes of rank 1 and rank 2, 0123400 and 0120056 respectively, yielding 0123456 in the buffer of the compute node of rank 0. The contents of the buffer of the compute node of rank 1, 0123400, are bitwise ORed with the contents of the buffers of the compute nodes of rank 3 and rank 4, 0123000 and 0120400 respectively, yielding 0123400 in the buffer of the compute node of rank 1. The contents of the buffer of the compute node of rank 2, 0120056, are bitwise ORed with the contents of the buffers of the compute nodes of rank 5 and rank 6, 0120050 and 0120006 respectively, yielding 0120056 in the buffer of the compute node of rank 2. Data processing accord to the method of FIG. 8 has so far has been effected with a reduce operation and a bitwise OR, but the overall result is that of a gather of the contribution data from each compute node into the buffer of the root compute node at rank positions in the buffer.

FIG. 9C illustrates the status of the memory buffers in each compute node (102) of the operational group just after a second of a series of broadcasts of interim results in step (312) of the method of FIG. 8. The contents of the buffer of the root compute node, rank 0, that is, 0123456, have been broadcast to all the compute nodes in the operational group, and all buffers in the operational group now contain the same value, 0123456. Broadcasting the interim results of the reduce operation effects an allreduce, step (304) in the method of FIG. 8. The effect of the allreduce combined with the initial configuration of the buffers is an allgather, a gather of the contribution data from each compute node into the buffer of the root compute node at rank positions in the buffer followed by a broadcast of the results of the gather to all compute nodes in the operational group.

Readers will recognize in view of the explanations set forth above that the benefits of executing an allgather operation on a parallel computer include that fact that reduce operations, and therefore collective allgather based on reduce operations, are very fast, even faster on networks with tree topologies, even faster on tree networks with a dedicated ALU in each compute node. Moreover, compare typical methods of executing an allgather according to the present invention compared with the prior art algorithm described above. The prior art method used one broadcast for each compute node in an operational group, a huge data communications burden in a group that may contain thousands of compute nodes where each compute node, according to this prior art algorithm would represent the need for a separate broadcast, thousands of broadcasts. Executing an allgather according to the present invention may be carried out with as little as a singe allreduce composed of a single reduce operation and a single broadcast. Other methods of executing an allgather according to embodiments of the present invention are carried out with only a small number of broadcasts, much, much fewer than the number required by the prior art method described above.

Exemplary embodiments of the present invention are described largely in the context of a fully functional computer system for executing an allgather operation on a parallel computer. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web.

Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for executing an allgather operation on a parallel computer, the parallel computer comprising a plurality of compute nodes, the compute nodes organized into at least one operational group of compute nodes for collective parallel operations of the parallel computer, each compute node in the operational group assigned a unique rank, the method comprising:
configuring on each compute node in the operational group a memory buffer with contribution data for an allreduce operation at a rank-dependent position in each memory buffer and zeros in all other positions in each memory buffer; and
executing on the compute nodes in the operational group, with the entire contents of each memory buffer, an allreduce operation with a bitwise OR function.

2. The method of claim 1 wherein the parallel computer further comprises a data communications network that includes data communications links connected to the compute nodes so as to organize the compute nodes as a tree.

3. The method of claim 1 wherein the parallel computer further comprises a data communications network that includes data communications links connected to the compute nodes so as to organize the compute nodes as a tree, each compute node having a separate ALU dedicated to parallel reduce operations.

4. The method of claim 1 wherein executing the allreduce further comprises:
executing on the compute nodes in the operational group a reduce operation with a bitwise OR, including producing an entire result of the reduce operation in a root compute node before broadcasting any portion of the result to compute nodes in the operational group; and
after producing an entire result of the reduce operation in a root compute node, executing on the compute nodes in the operational group a single broadcast of the result of the reduce operation.

5. The method of claim 1 wherein executing the allreduce further comprises:
executing on the compute nodes in the operational group a reduce operation with a bitwise OR, including producing a series of interim results of the reduce operation into the root compute node from other compute nodes in the operational group; and
while producing the series of interim results, executing on the compute nodes in the operational group a corresponding series of broadcasts of the interim results of the reduce operation.

6. A parallel computer for executing an allgather operation, the parallel computer comprising a plurality of compute nodes, the compute nodes organized into at least one operational group of compute nodes for collective parallel operations of the parallel computer, each compute node in the operational group assigned a unique rank, the parallel computer comprising a computer processor, a computer memory operatively coupled to the computer processor, the computer memory having disposed within it computer program instructions capable of:
configuring on each compute node in the operational group a memory buffer with contribution data for an allreduce operation at a rank-dependent position in each memory buffer and zeros in all other positions in each memory buffer; and
executing on the compute nodes in the operational group, with the entire contents of each memory buffer, an allreduce operation with a bitwise OR function.

7. The parallel computer of claim 6 wherein the parallel computer further comprises a data communications network that includes data communications links connected to the compute nodes so as to organize the compute nodes as a tree.

8. The parallel computer of claim 6 wherein the parallel computer further comprises a data communications network that includes data communications links connected to the compute nodes so as to organize the compute nodes as a tree, each compute node having a separate ALU dedicated to parallel reduce operations.

9. The parallel computer of claim 6 wherein executing the allreduce further comprises:
executing on the compute nodes in the operational group a reduce operation with a bitwise OR, including producing an entire result of the reduce operation in a root compute node before broadcasting any portion of the result to compute nodes in the operational group; and
after producing an entire result of the reduce operation in a root compute node, executing on the compute nodes in the operational group a single broadcast of the result of the reduce operation.

10. The parallel computer of claim 6 wherein executing the allreduce further comprises:
executing on the compute nodes in the operational group a reduce operation with a bitwise OR, including producing a series of interim results of the reduce operation into the root compute node from other compute nodes in the operational group; and
while producing the series of interim results, executing on the compute nodes in the operational group a corresponding series of broadcasts of the interim results of the reduce operation.

11. A computer program product for executing an allgather operation on a parallel computer, the parallel computer comprising a plurality of compute nodes, the compute nodes organized into at least one operational group of compute nodes for collective parallel operations of the parallel computer, each compute node in the operational group assigned a unique rank, the computer program product disposed upon a signal bearing medium, the computer program product comprising computer program instructions capable of:
configuring on each compute node in the operational group a memory buffer with contribution data for an allreduce operation at a rank-dependent position in each memory buffer and zeros in all other positions in each memory buffer; and
executing on the compute nodes in the operational group, with the entire contents of each memory buffer, an allreduce operation with a bitwise OR function.

12. The computer program product of claim 11 wherein the signal bearing medium comprises a recordable medium.

13. The computer program product of claim 11 wherein the signal bearing medium comprises a transmission medium.

14. The computer program product of claim 11 wherein the parallel computer further comprises a data communications network that includes data communications links connected to the compute nodes so as to organize the compute nodes as a tree.

15. The computer program product of claim 11 wherein the parallel computer further comprises a data communications network that includes data communications links connected to the compute nodes so as to organize the compute nodes as a tree, each compute node having a separate ALU dedicated to parallel reduce operations.

16. The computer program product of claim 11 wherein executing the allreduce further comprises:
executing on the compute nodes in the operational group a reduce operation with a bitwise OR, including producing an entire result of the reduce operation in a root compute node before broadcasting any portion of the result to compute nodes in the operational group; and
after producing an entire result of the reduce operation in a root compute node, executing on the compute nodes in the operational group a single broadcast of the result of the reduce operation.

17. The computer program product of claim 11 wherein executing the allreduce further comprises:
executing on the compute nodes in the operational group a reduce operation with a bitwise OR, including producing a series of interim results of the reduce operation into the root compute node from other compute nodes in the operational group; and
while producing the series of interim results, executing on the compute nodes in the operational group a corresponding series of broadcasts of the interim results of the reduce operation.
